(19) United States
(12) Patent Application Publication
(10) Pub. No.: US 2017/0372422 A1
(43) Pub. Date: Dec. 28, 2017

(54) SYSTEMS AND METHODS FOR IMPROVED EXECUTION, TRACKING, SHARE REVALUING AND ALLOCATION OF LEVERAGED EXCHANGE TRADED FUNDS

(71) Applicant: Emerald Development Group Inc., Hoboken, NJ (US)

(72) Inventor: Thomas A. Hays, Hoboken, NJ (US)

(21) Appl. No.: 15/631,419

(22) Filed: Jun. 23, 2017

Related U.S. Application Data
(60) Provisional application No. 62/353,999, filed on Jun. 23, 2016.

(51) Int. Cl. G06Q 40/04; G06Q 40/00; G06Q 30/02; G06Q 40/06

(52) U.S. Cl. CPC G06Q 40/04; G06Q 40/06; G06Q 40/12; G06Q 30/0201; G06Q 40/00

(57) ABSTRACT

Methods, systems and tools reflect inter-day reference asset changes in an Leveraged Exchange Traded Funds (LETF) through end of trading day share splits or consolidations. In the event that the value of a reference asset has increased, the number of unredeemed shares is adjusted by performing a split relative to a first creation date and a value of the reference asset at a second set time. In the event that the value of the reference asset has decreased, the number of unredeemed shares is adjusted by performing a consolidation relative to the first creation date and the value of the reference asset at the second set time. The second price of the adjusted unredeemed shares is adjusted to the first set price. The adjusted number of unredeemed shares is allocated to each of the one or more purchasers.

### CROSS-REFERENCE TO RELATED APPLICATIONS

This patent application claims the benefit of priority of U.S. Ser. No. 62/353,999, filed Jun. 23, 2016, entitled Systems and Methods for Improved Execution, Tracking, Revaluing, and Share Allocation of Leveraged Exchange Traded Funds, which is hereby incorporated by reference as if set forth in its entirety herein.

### FIELD OF THE INVENTION

The invention described herein generally relates to systems, methods and computer program products for customizing, allocating, and executing security investment orders. In particular, the invention relates to systems, methods, and computer program products for adjusting shares of leveraged exchange traded funds based on changes in the value of the underlying fund position created on the day the shares were purchased, and providing custom intra-day pricing multiples based on the day the shares were purchased.

### BACKGROUND OF THE INVENTION

Current Leveraged Exchange Traded Funds (LETF) must be rebalanced daily in order to meet their stated multiple return (e.g., 2×, −2×, etc.) relative to one or more underlying reference assets (e.g., a financial instrument such as an index) which the fund tracks, and this stated multiple return is valid only for the next trading day. A LETF rebalances by changing the total amount of exposure the fund has through underlying assets, financial derivatives and/or debt, such that the exposure relative to the fund's assets remains equal to the stated multiple ratio for the next trading day. Without rebalancing, the LETF leverage ratio would change as the reference asset fluctuates, thereby making the stated multiple impossible. Conventional LETFs rebalance daily, usually at market close, and such frequent adjustments result in significant transaction and computing costs which cannot be quantified a priori and which are highly dependent of market volatility. Moreover, traditional LETFs do not provide the stated multiple for periods greater than one trading day. Hence, traditional LETFs are used primarily as a day trading vehicle, and are not appropriate as a buy and hold vehicle.

It is with regard to these and other needs that the present disclosure is provided.

### SUMMARY OF THE INVENTION

According to a broad aspect of the invention, methods and systems for executing, tracking, share adjusting, and allocating (i.e., managing) a leveraged exchange traded fund (LETF) are provided in which rebalancing is not required and conventional floating price methods do not apply.

In accordance with one aspect of the invention, a method of managing a leverage exchange traded fund (LETF), the LETF having an exposure ratio proportional to a multiple of the change in value of an reference asset over time is provided. The method generates, at a first set time, a first creation unit having a first creation date, the first creation unit including one or more shares relative to the value of the reference asset at the first set time, each share having a first set price value. In one or more embodiments, the method determines, prior to the first time, the value of the reference asset. Then, the method receives, one or more trading orders purchasing one or more shares by one or more purchasers. Further, the method determines, at a second set time, which of the one or more shares were purchased but not yet redeemed by the one or more purchasers since the first set time, and determines, at the second set time, the value of the reference asset and determining, as a second price, the price of the one or more purchased shares. In one or more implementations, the method generates, at the second set time, a second creation unit having a second creation date, the second creation unit including one or more shares relative to the value of the reference asset at the second set time, each share having a set price value.

Continuing with this aspect of the invention, in the event that the value of the reference asset has increased, the method adjusts the number of unredeemed shares by performing a split relative to the first creation date and the value of the reference asset at the second set time. In the event that the value of the reference asset has decreased, the method adjusts the number of unredeemed shares by performing a consolidation relative to the first creation date and the value of the reference asset at the second set time. In one or more implementations, the adjustment of the number of unredeemed shares by a split or a consolidation includes adjusting the number of unredeemed shares to maintain the exposure ratio proportional to the multiple of the change in value of a reference asset over time. Further, the method adjusts the second price of the adjusted unredeemed shares to the first price. The method additionally allocates the adjusted number of unredeemed shares to each of the one or more purchasers.

Continuing with this aspect of the invention, in one or more implementations, the method additionally determines, at a third set time, which of the one or more shares of the creation unit are available for purchase, and determines, at the third set time, the value of the reference asset. In one or more implementations, the third set time is after the first set time but before the second set time. For example, the third set time is a time after market open and before market close (i.e., intra-day trading). The determination of a value of the reference asset and the adjustment of a share price aspect may be repeated at other times between the first set time and the second set time.

In accordance with another aspect of the invention, a system for managing a leverage exchange traded fund (LETF), the LETF having an exposure ratio proportional to a multiple of the change in value of an reference asset over time is provided. The system includes a computing device, the computing device having a processor, a memory, and a communication link to a network. Further, the system includes a central server configured to, across the network, interface with one or more financial exchanges and the computing device.

Continuing with this aspect of the invention, the system also includes one or more modules implementing instructions stored in the memory by the processor to configure the processor to perform various actions. In one or more implementations, the system includes a market creation module for configuring the processor to generate, at a first set time, a first creation unit having a first creation date, the first creation unit including one or more shares relative to the value of the reference asset at the first set time, each share having a set price value at the first set time, and receive, one or more trading orders purchasing one or more shares by one or more purchasers. In one or more implementations, the system includes a market maker module for configuring the processor to receive, one or more trading orders purchasing the one or more shares by one or more purchasers. In one or more implementations, the system includes an execution module for configuring the processor to execute the one or more received purchase orders by transmitting the one or more trading orders to the central server. In one or more implementations, the system includes a broker module for configuring the processor to determine, at a second set time, the value of the reference asset relative to the first set time and adjust the one or more shares purchased but not redeemed from the creation unit. In the event that the value of the reference asset has increased, the broker module configures the processor to perform a split to generate additional shares to account for the difference of the value of the reference asset at the first set time and the second set time. In the event that the value of the reference asset has decreased, the broker module configures the processor to perform a consolidation to redeem one or more shares to account for the difference of the value of the reference asset at the first set time and the second set time. In one or more implementations, the broker module further configures the processor to adjust the price of the adjusted unredeemed shares to the price of the one or more shares at the first set time, and allocate the adjusted number of unredeemed shares to each of the one or more purchasers.

These and other aspects, features, and advantages of the invention can be further appreciated from certain implementations of the invention described herein.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A presents an illustration of an exemplary implementation of an LETF method as known in the prior art;

FIG. 1B presents an illustration of the exemplary LETF implementation method in FIG. 1A;

FIG. 1C presents a continuation of the illustration of the exemplary LETF implementation method in FIG. 1A;

FIG. 2 presents a block diagram of a system for executing, tracking, share adjusting and allocation of leveraged exchange traded funds according to one or more implementations of the present invention;

FIG. 3 presents a block diagram of the software modules encoded in hardware components of the system of FIG. 2 according to one or more implementations of the present invention;

FIG. 4 presents a flow diagram of an exemplary method for executing, tracking, share adjusting and allocation of an LETF according to one or more implementations of the present invention;

FIG. 5A presents an exemplary implementation of the system for executing, tracking, share adjusting and allocation of a LETF vehicle purchase for a first investor according to one or more implementations herein;

FIG. 5B presents an exemplary implementation of the system for executing, tracking, share adjusting and allocation of a LETF vehicle purchase for a second investor according to one or more implementations of the present invention;

FIG. 6 presents a method of intra-day processing of purchased LETF shares from a creation unit according to one or more implementations of the present invention;

FIG. 7 presents a high-level diagram illustrating the inter-day and intra-day components of methods and systems according to one or more implementations of the present invention;

FIG. 8A presents an exemplary implementation of the methods and systems according to one or more implementations of the present invention;

FIG. 8B presents a continuation of the exemplary implementation of FIG. 8A;

FIG. 9 presents an exemplary implementation of how the methods and systems herein generate market exposure according to one or more implementations of the present invention;

FIG. 10 presents flow diagrams illustrating a creation unit during the generation, purchase, and redemption process according to one or more implementations of the present invention;

FIG. 11 presents a flow diagram illustrating a secondary market work process according to one or more implementations of the present invention;

FIG. 12 presents a flow diagram illustrating a recycling of already generated shares into new creation units according to one or more implementations of the present invention; and

FIG. 13 presents an exemplary administrative notification system implemented by the methods and systems according to one or more implementations of the present invention.

### DETAILED DESCRIPTION OF THE INVENTION

Throughout the specification, terms may have nuanced meanings suggested or implied in context beyond an explicitly stated meaning. Likewise, the phrase “in one implementation” as used herein does not necessarily refer to the same implementation and the phrase “in another implementation” as used herein does not necessarily refer to a different implementation. Similarly, the phrase “one or more implementations” as used herein does not necessarily refer to the same implementation and the phrase “at least one implementation” as used herein does not necessarily refer to a different implementation. The intention is, for example, that claimed subject matter includes combinations of example implementations in whole or in part.

Exchange traded funds (ETF) are investment funds which track the performance of one or more underlying reference assets, such as commodities, stocks or bonds, or an index (e.g., S&P 500, Russell 2000, Nasdaq 100). As such, ETF performance is intended to mirror the performance of the reference assets and is able to trade close to the underlying fund portfolio's net asset value (NAV). An ETF is traded on a financial exchange via buying and selling of shares generated from a creation unit. A creation unit is a block of shares that are made available by a party for individual investors to purchase. ETFs are open-ended investment vehicles, meaning creation units, and shares that are issued from them, can be created and redeemed as needed.

Like an ETF, a leveraged exchange traded fund (LETF) tracks the performance of one or more underlying reference assets. However, a LETF provides amplified returns relative to the reference asset by also investing in financial derivatives (e.g., futures contracts, swaps, etc.) or taking on debt to create a set amount of leverage during the next trading day. For example, an LETF that tracks the S&P500 may invest in S&P500 future contracts. LETF returns relative to the reference asset may be amplified positively at a 2:1, 3:1 or other ratio, or in the case of an inverse LETF, amplified negatively (e.g., −2:1, −3:1, etc.) relative to the next trading day. Thus, for a LETF having a 2:1 ratio, if the reference asset returns 1% during the trading day in question, the traditional LETF would return 2% during the same trading day, prior to fees and costs. Similarly, if the reference asset drops by 1% during the trading day in question, the LETF would return −2% during the same trading day, prior to fees and costs.

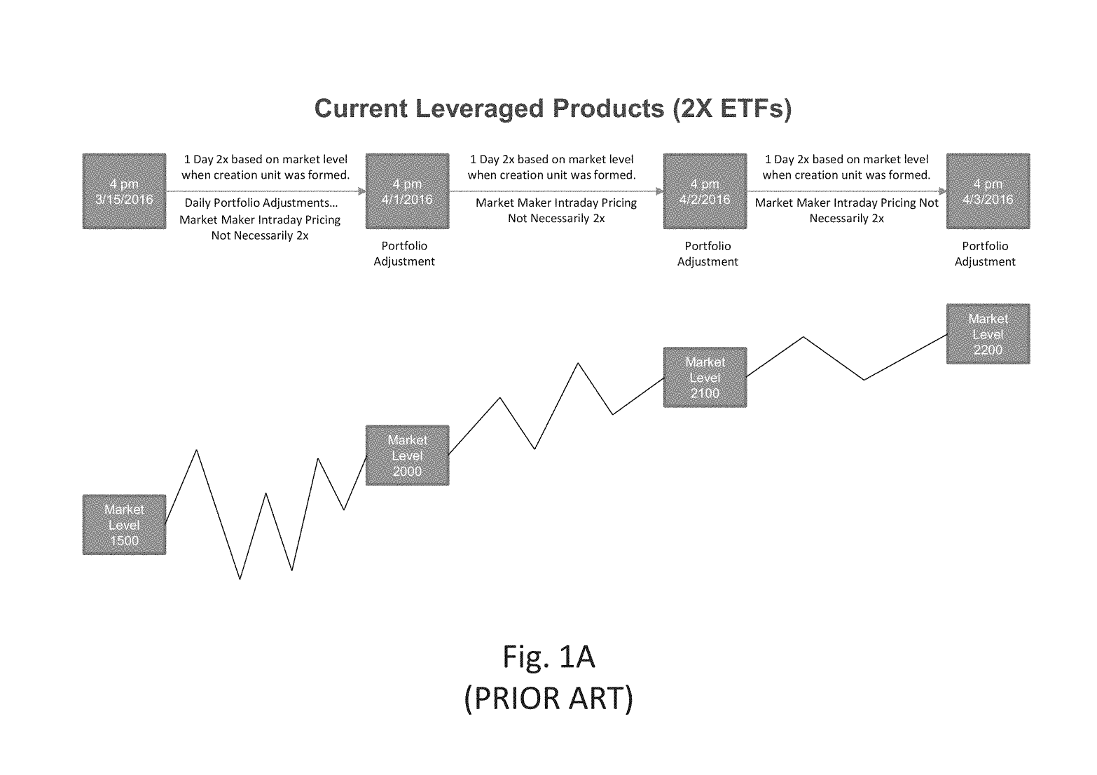

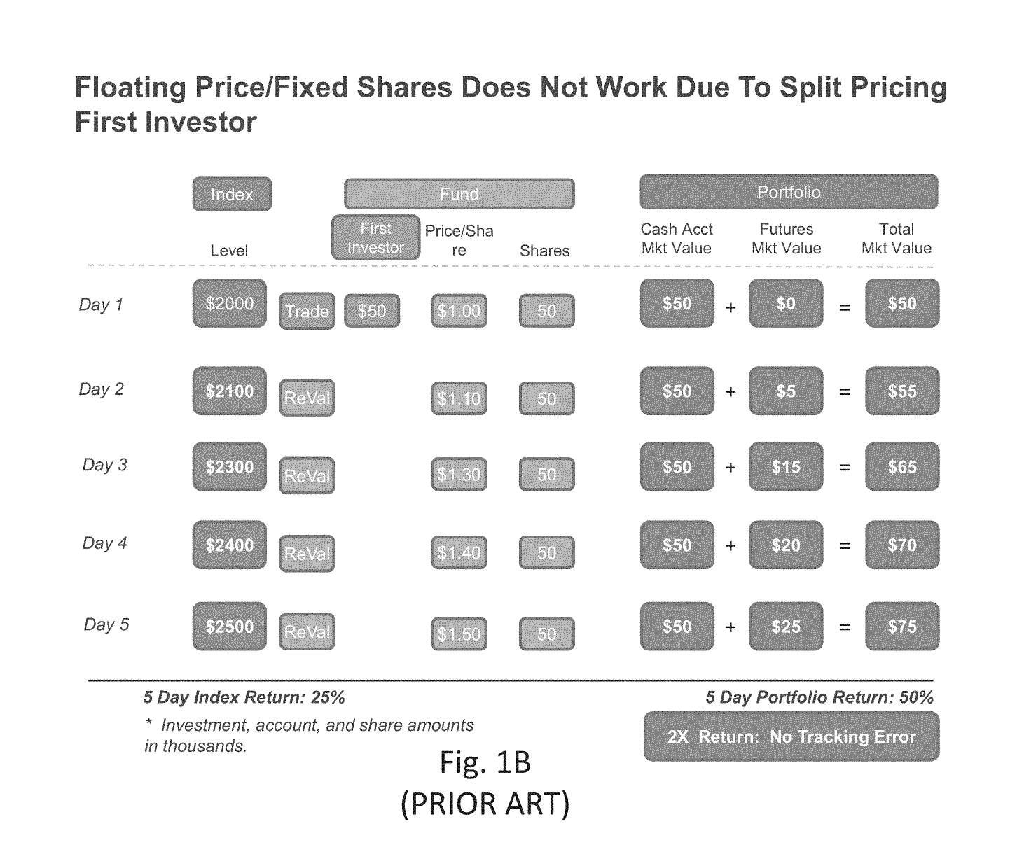

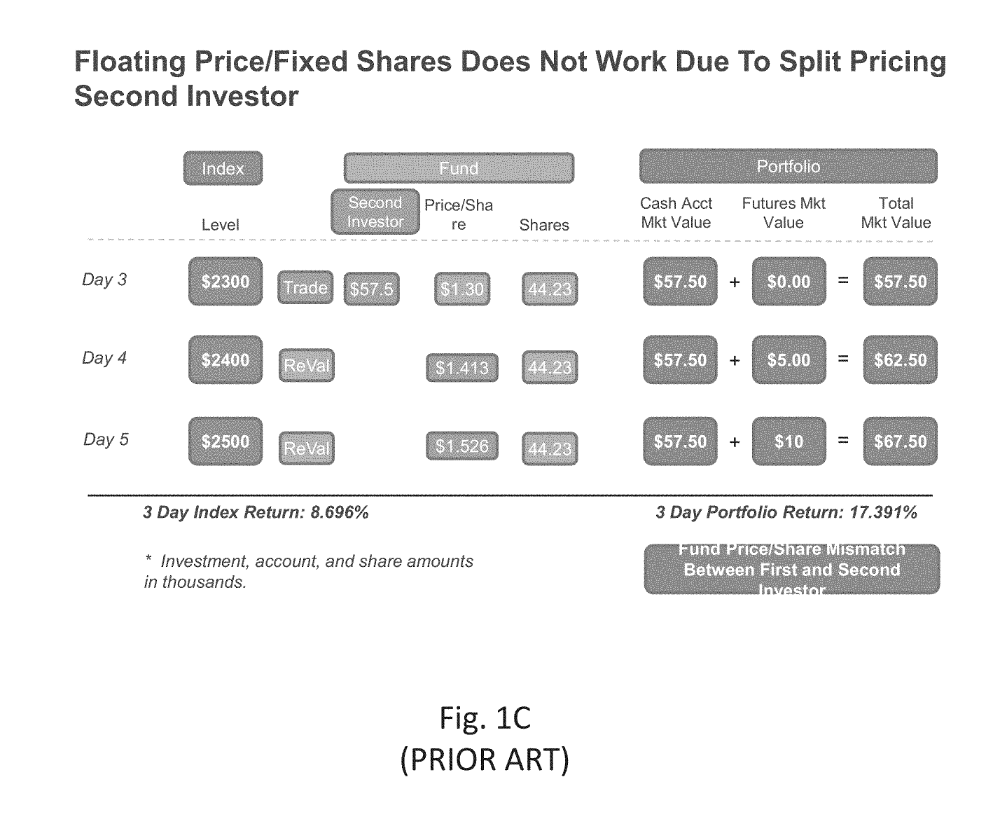

With reference to FIG. 1A, an example prior art LETF method that requires rebalancing is illustrated. LETFs of this type must maintain a constant fund to underlying portfolio exposure ratio consistent with the leveraged (multiple) ratio for each trading day. Thus, if the LETF provides a positive return during a trading day, additional exposure must be generated to maintain the same multiple ratio for the next trading day. Similarly, if the LETF provides a negative return during a trading day, the fund must reduce its exposure to maintain the same multiple ratio for the next trading day. Because of this, prior art methods rebalance the LETF portfolio at the end of each trading day by buying and selling the assets held by the LETF to maintain the stated multiple, as shown in FIG. 1A. This rebalancing introduces large daily transaction costs, which make conventional LETF vehicles unattractive for long-term buy and hold strategies. Furthermore, since transaction costs related to LETF portfolio rebalancing are highly dependent on market volatility, net LETF returns relative to the underlying reference asset cannot be forecasted with accuracy. Moreover, rebalancing changes the stated multiple ratio relative for investors holding their shares for more than one day.

Conventionally, the value of LETF shares relative to the underlying reference asset is maintained by changing the price of the LETF shares as the value of the reference asset fluctuates. This price applies to all LETF shares issued regardless of which trading day they were purchased on, and what market level they were purchased at. This “floating price” method means that though the price of the fund is varied as the tracked reference asset changes, the amount of shares owned by an investor remains constant. This introduces a problem because the LETF would have to provide different purchase prices for investors who buy shares on different days and market levels in order to maintaining the stated multiple across many investors.

Turning to FIG. 1B, the prior art LETF execution, tracking, revaluing and allocation system and method of FIG. 1A that requires rebalancing is shown with exemplary reference asset values and investment for a first investor. In this example, the reference asset tracked is an index with an initial market value on Day 1 of $2000, and is leveraged to provide a 2:1 multiple by purchasing futures contracts that track the reference asset. A first creation unit is generated on Day 1 that represents $50 worth of shares pegged to a creation unit having a price of $1/share. The system then allocates 50 shares of the fund to the investor from the creation unit. As no adjustments have been made, these shares have a cash account market value of $50, and a futures value of $0, since the index value has yet to change. On Day 2, the reference index rises 5% to a value of $2100. In response, the price per share is increased to $1.10, representing a 10% increase in value to maintain the 2:1 multiple. On Days 3-5, the reference index continues to rise to a total of $2500 (a 25% cumulative increase from Day 1), and the price per share is increased to $1.50 (a 50% cumulative increase from Day 1 to maintain the 2:1 multiple). There are no tracking errors for this first investor.

However, as shown in FIG. 1C, the prior art system and method fails at maintaining a consistent price among later in time investors while still providing the stated multiple. In this example, the second investor purchases $57.50 in shares on Day 3 at a price of $1.30 due to the current index value relative to the creation unit date (Day 1). This provides the second investor with a total of 44.23 shares. On Days 4 and 5, the reference index rises and the prior art rebalances the price of the shares to maintain the stated 2:1 multiple, as shown in FIG. 1C. However, because the second investor made its initial purchase at a different price point than the first investor but from the same creation unit, a mismatch arises between the price points of the shares owned by the investors as the value of the reference index changes on Days 4 and 5. In particular, while the price of the shares of the first investor rises to $1.4 and $1.5 respectively, the price of the shares of the second investor rises to $1.413 and $1.526 respectively. This mismatch means that each individual investor and its price point must be tracked for any investors that hold their investment for more than one day, which is currently not possible using conventional LETF systems and methods.

The present disclosure details systems and methods for improved execution and tracking abilities of leveraged exchange traded funds (LETF) vis-a-vis their referenced asset. As current approaches in the technical field of processing LETFs, including the need to rebalance the LETF's underlying portfolio on a daily basis, have not been highly effective or efficient in executing share trades that track the referenced asset for long-term (i.e., end to end hold periods greater than a day) investment strategies, the present systems and methods employ hardware, software, and/or a combination of the two to utilize various algorithms that execute in a machine and eliminate the need to rebalance a LETFs underlying portfolio on a daily basis, and provide the stated multiple for hold periods of greater than one day regardless of which trading day the LETF shares were purchased on, and what market level they were purchased at. Particularly, one or more software modules implementing code in a machine consist of an algorithmic investment approach to customize the investment return for each individual investor regardless of what the reference asset is at when the investor purchases shares. In this way, the technical field of LETF processing is improved by eliminating the need for daily rebalancing and reducing accompanying technical (e.g., computer resources, network bandwidth, number of executed trades necessary) and financial costs.

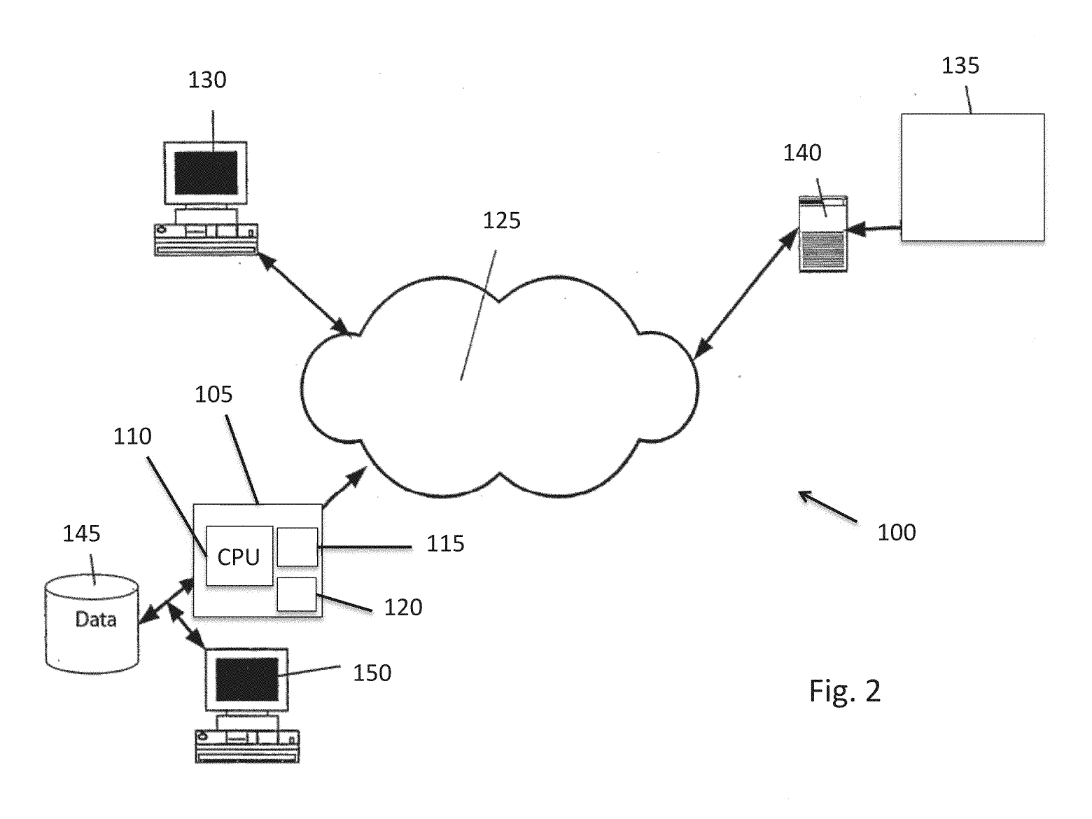

With reference now to FIG. 2, an exemplary system illustrates a configuration of a system for processing, executing, and revaluing the share allocation of a LETF vehicle tracking one or more underlying reference asset(s) according to one or more implementations provided herein. In this arrangement, the system 100 includes hardware components of a host computer server 105 having a processor 110, one or more memories 115, and a storage 120 that interfaces the system 100 with a distributed computer network system 125. The distributed computer network system 125 can be any type of inter-computer communication system that connects computers in a distributed manner. Examples include, but are not limited to, the Internet, an intranet, LAN, or WAN. One or more user computing devices 130 are connected via the computer network 125 to the system 100. The user computing devices 130 can be, for example, desktops, laptops, mobile devices, or tablets.

The system 100 is in communication with at least one central financial exchange 135 through the communication network 125. A financial exchange 135 provides a marketplace in which the assets owned by an LETF are bought and sold. For example, the financial exchange 135 may be a futures exchange, a swaps market, or other derivative market (e.g., exchange-traded or over-the-counter). The financial exchange 135 can be a public or private market. The financial exchange 135 contains an away server 140 for processing investment orders. In one or more implementations, the system 100 is capable of connecting to one or more financial exchanges through network 125 in order to execute trades of different types or amounts. In one or more implementations, the server 105 of the system 100 has access to a database 145 and a user terminal 150. Server 105 is controlled by a system control program (not shown) which operates to create the share revaluing and allocation system of the present invention by storing, displaying, modifying, transmitting, and securing the data pertaining to market orders necessary in the series of transactions needed to accomplish the daily adjustments to the LETF.

Investors connect to the system 100 client program or a client Application Program Interface, API (“Client”) provided at the user computing device 130 to connect to the system 100 secure server 105 (“Server”). The Client can be downloaded and installed at the user computing device 130, or can be accessed through the network 125 via a web portal, remote connection, or similar interface. The Server 105 is capable of maintaining electronic communication with many Clients simultaneously. After a Client establishes a connection with the Server 105, system 100 initiates a login sequence using a suitable module thereof by sending a login request message to the Client. If the Server is able to successfully authenticate the credentials transmitted in the login request, the Server sends a login approval message back to the Client, and thus both parties are said to enter a secure logical connection (“Session”) that remains valid until the electronic connection is broken.

An investor purchases or redeems LETF shares using system 100. First an investor logs on as a client and enters into a valid trading session with the Server 105. The investor then instructs the Server 105 as to the number of shares of the LETF to buy or sell. The Server 105 then communicates with the financial exchange 135 through the network 125 and executes a matching trade. For security purposes, trading sessions can require completing an authentication sequence, as is known in the art.

Database 145 can be a persistent database that is an integral part of the Server 105 or a stand-alone database hosted on a different server, computer, or network-accessible device. Within database 145 are stored registered clients' credentials and business rules. The Server 105 creates event logs within database 145. The event logs contain order entries, user log in activity, execution results, order generation, messages from/to exchanges, etc. The event logs are used to assure that a complete as possible depository of all system activities is maintained for audit purposes. The event logs can be used in case of a system crash to recreate the state of the system prior to crashing. The Server 105 also maintains a synchronized copy of a portion of the database 145, where current state of all outstanding trade orders is recorded, in its memory.

As a convenience for its market participants, the system 100 supports the notion of a trading account (“Account”). By assigning account identifiers to all orders, the Client can divide its Session into parallel sub-sessions for easier bookkeeping. The system control program is flexible in terms of its ability to use network technologies and data transmission protocols. A single Server may be configured to maintain concurrent Sessions carried by different communication media and protocols. The most common of these are TCP/IP socket streams over private lines and the industry-standard FIX protocol.

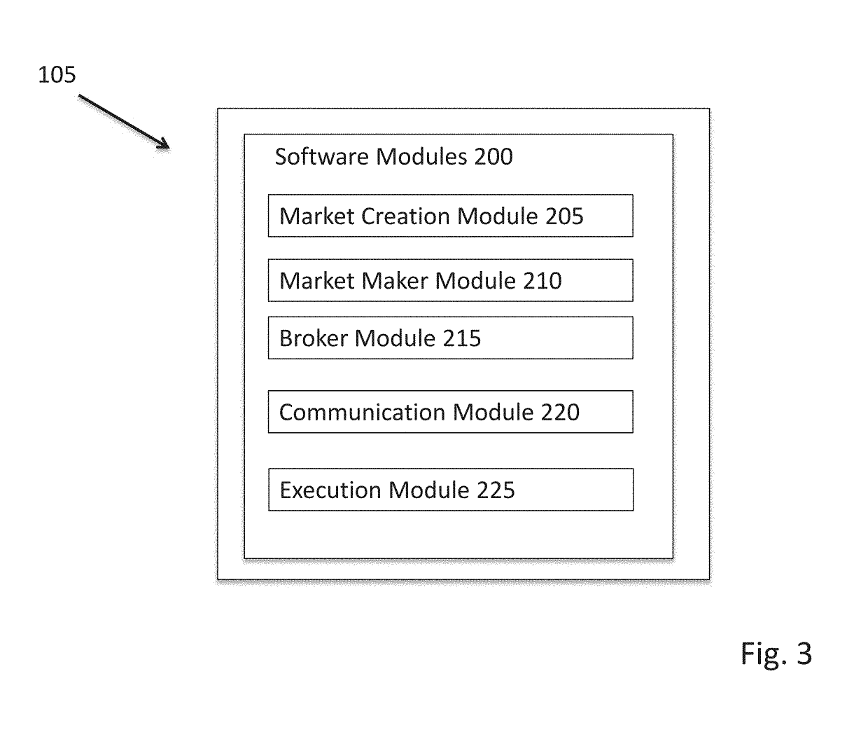

With reference now to FIG. 3, one or more software modules 200 are encoded in the memory 115 and/or the storage 120. The software modules 200 can comprise one or more software programs or applications having computer program code or a set of instructions implemented by the processor 110. Such computer program code or instructions for carrying out operations and implementing aspects of the systems and methods disclosed herein can be written in any combination of one or more programming languages. The program code can execute entirely on server 105, as a stand-alone software package, partly on the server and partly on a remote computer/device (e.g., user computing device 130) or entirely on such remote computers/devices. In the latter scenario, the remote computer systems are connected to server 105 through any type of network (e.g., network 125), including a local area network (LAN) or a wide area network (WAN), or the connection can be made through an external computer (for example, through the Internet using an Internet Service Provider).

In one or more implementations, one or more software modules 200 implement program code to execute aspects of the present invention. A market creation module 205 is included that obtains market exposure by executing one or more trades concerning financial derivatives (e.g., futures contracts tied to the performance of a particular reference index) to generate or redeem a creation unit which is divided into shares and sold to investors. A market maker module 210 is included that calculates an accurate intra-day multiple change in value of LETF shares relative to intra-day market fluctuations in the reference asset. Calculation and change in value for inter-day market fluctuations can be allocated to LETF shares via daily share splits or consolidations based on the creation unit day and market level when the share was issued.

In one or more implementations, the server 105 includes additional modules. For example, a broker module 215 can be included for reallocating assets during buy/sell orders, one or more communication modules 220 for communicating between host server 105, computing device 130, and away server 140, and an execution module 225 for executing orders by transmitting the one or more trading orders to the away server from a user computing device. During execution of the software modules 200, the processor 110 is configured to perform various operations relating to the execution and allocation of LETFs, as will be described in greater detail below. It is important to note that the specific features of the one or more software modules 200 described herein are provided as an example implementation. In one or more implementations, some or all of the features described as being performed by a particular software module 200 may be performed by one or more of any of the other software modules without departing from the scope of the invention herein. For example, the features of the execution module 225 may be incorporated into the market maker module 210 or the broker module 215 in one or more implementations.

It can also be said that the program code of the software modules 200 and one or more of the non-transitory computer readable storage devices (such as the memory 115 and/or the storage 120) form a computer program product that can be manufactured and/or distributed in accordance with the present disclosure, as is known to those of ordinary skill in the art.

Through implementation of program code, market creation module 205 is configured to create an LETF instrument in accordance with one or more implementations provided herein. For example, as LETFs are composed of cash, borrowed funds, shares of underlying referenced assets, and/or futures or derivative instruments, in order to accurately represent the underlying assets, market creation module 205 can generate one or more creation units which track the reference asset (e.g., the index) exclusively with authorized market participants (Market Makers) who will create a market to allow intra-day trading. Each creation unit comprises one or more shares for investor purchase. Creation units can then be redeemed for cash, and/or shares of the underlying assets, futures, or derivatives depending on corresponding demand for the LETF shares. For example, the market creation module 205 can cause investments to be made in the LETF in cash, or through the assignment of futures or derivative contracts, and underlying referenced assets. In the case of cash investments, the LETF obtains market exposure in order to produce a target return multiple by investing in futures and/or derivative contracts, which track the underlying reference asset as well as investing cash in the underlying asset itself. In one or more implementations, market creation module 205 configures the LETF fund to deal exclusively with authorized marked participants (Market Makers) who exclusively create and redeem creation units with the LETF, and then buy and sell shares created from these creation units to investors through the various Broker Dealers who represent investors in the market. For example, when creating a creation unit that will track the respective asset only by investing cash, the LETF will receive cash collateral from Market Makers in the amount equal to (for 2× LETFs) the market value of the futures contract divided by the stated LETF multiple. To create a cash investment of an amount X, for a 2:1 target, the LETF must invest in a futures contract of value 2×. For example, for a futures contract value of $115,000, the total cash balance required would be $57,500. The difference between the futures and spot price of the underlying asset (adjusted for dividends, financing and holding costs, etc., as the case may be) is considered as the net financing cost of the futures position versus the spot position (i.e., current asset price). In one or more implementations, market creation module 205 configures creation units having data pertaining to creation date (i.e., purchase date), market level, and target multiple of return (e.g., 2:1, 3:1).

In one or more implementations, the market creation module 205 is configured to generate, at a first set time, a first creation unit having a first creation date, the first creation unit including one or more shares relative to the value of the reference asset at the first set time, each share having a set price value at the first set time. The market creation module 205 is also configured to receive, one or more trading orders purchasing one or more shares by one or more purchasers.

Through implementation of program code, market maker module 210 is configured to revalue the LETF shares as a result of reference asset price changes from close of one trading day to the close of the next trading day, by changing the allocation of the number of shares owned by a particular investor that correlate to a particular creation unit (i.e., the shares on their purchase date). In one or more implementations, the inter-day share adjustment and the intra-day price multiple are customized and allocated for each share based on a creation unit date, and a creation unit market level from which the share is issued through a combination of one or more of the software modules presented herein. In one or more implementations, the set per share fund price for new creation units (and shares issued from them respectively), and their subsequent once a day share adjustments will be based on a fixed price (e.g., $1) as opposed to a floating price, which is the case with conventional LETFs. In one or more implementations, LETF shares are adjusted once daily via splits or consolidations. For example, the shares may be adjusted when markets close (e.g., 4 pm daily). Adjustments are performed through splits or consolidations to reflect the day-to-day change in the value of the LETF since the previous day's share adjustment. These splits and consolidations are analogous to stock splits and stock consolidations, respectively, except that they operate on the number of authorized shares of the LETF; throughout the disclosure “splits” and “consolidations” refer to share splits of the LETF and share consolidations of the LETF, respectively. Market maker module 210 also facilitates pricing by Market Makers regarding change in value of the LETF relative to a previous adjustment of LETF shares (or shares on issuance date if no previous adjustment has been made). In this way, for intra-day trading the accurate multiple regarding the change in price of the LETF relative to the intra-day market move in the underlying reference security is provided regardless of the issuance date and market level of the related creation unit. For a LETF with a target cumulative multiple of 2×, the intra-day (between daily share adjustments) LETF multiple will vary for shares purchased on previous trading days depending on the initial market level when the relevant creation unit was issued (the creation unit from which the shares were issued/purchased). The 2× return is the stated target multiple of the return of the creation unit (from which the share is issued) relative to the change in value of the underlying assets siloed in the fund at the time that the creation unit was issued.

In one or more implementations, the market maker module 210 is configured by a processor to receive one or more trading orders purchasing the one or more shares by one or more purchasers. In one or more implementations, the market maker module 210 is configured to, upon receiving a trading order, to adjust the intra-day price of the shares. For example, the market maker module 210 can adjust the share price to reflect the price of the underlying reference asset before execution of the trading order. Meaning, if the reference asset price fluctuates intra-day, the market maker module 210 will fill trading orders to reflect the stated multiple relative to the current reference asset price based on the adjusted number of shares and an intra-day multiple that provides the stated multiple based on the creation unit date and market level from which the shares were issued.

Through implementation of program code, broker module 215 is configured to facilitate the accurate allocation of splits or consolidations internally for the clients of Market Makers and Broker Dealers, which hold shares of the LETF in Market Maker, Broker Dealer, bank, or other custodial electronic accounts. In one or more implementations, broker module 215 provides the accurate inter-day change in the number of LETF shares based on the date of share purchase and market level when its respective creation unit was issued. For example, this change in number of shares can be a function of the market movement in the underlying reference asset since the previous day's adjustment of LETF shares.

In one or more implementations, the broker module 215 is configured by the processor 110 to determine, at a second set time, the value of the reference asset relative to a first set time. For example, the first set time can be the value of the reference asset at market close, and the second set time can be the value of the reference asset at the next market close. The broker module 215 then can adjust the one or more shares purchased but not redeemed from the creation unit depending on the difference in value of the reference asset from the first set time and the second set time. In the event that the value of the reference asset has increased, the broker module 215 performs a split to generate additional shares to account for the difference of the value of the reference asset at the first set time and the second set time. In the event that the value of the reference asset has decreased, perform a consolidation to redeem one or more shares to account for the difference of the value of the reference asset at the first set time and the second set time. The broker module 215 is also configured to adjust the price of any adjusted unredeemed shares to the set price of the one or more shares at the first set time. In other words, the price of any outstanding shares is reset to a baseline price (e.g., $1). The broker module 215 can then allocate the adjusted number of unredeemed shares to each of the one or more purchasers.

Through implementation of program code, communication module 220 is configured to enable communication between system 100 (e.g., between server 105 and away server 140) and communication over the network 135 between system 100, user computing devices 130, and financial exchange 135. In one or more implementations, communication module 220 functions in conjunction with hardware elements such as network cards. Through implementation of program code, execution module 225 is configured to execute buy and sell trades of the LETF portfolio in conjunction with one or more of the software modules 200. In one or more implementations, execution module 225 instructs the communication module 220 to transmit a buy or sell order to the financial exchange 135.

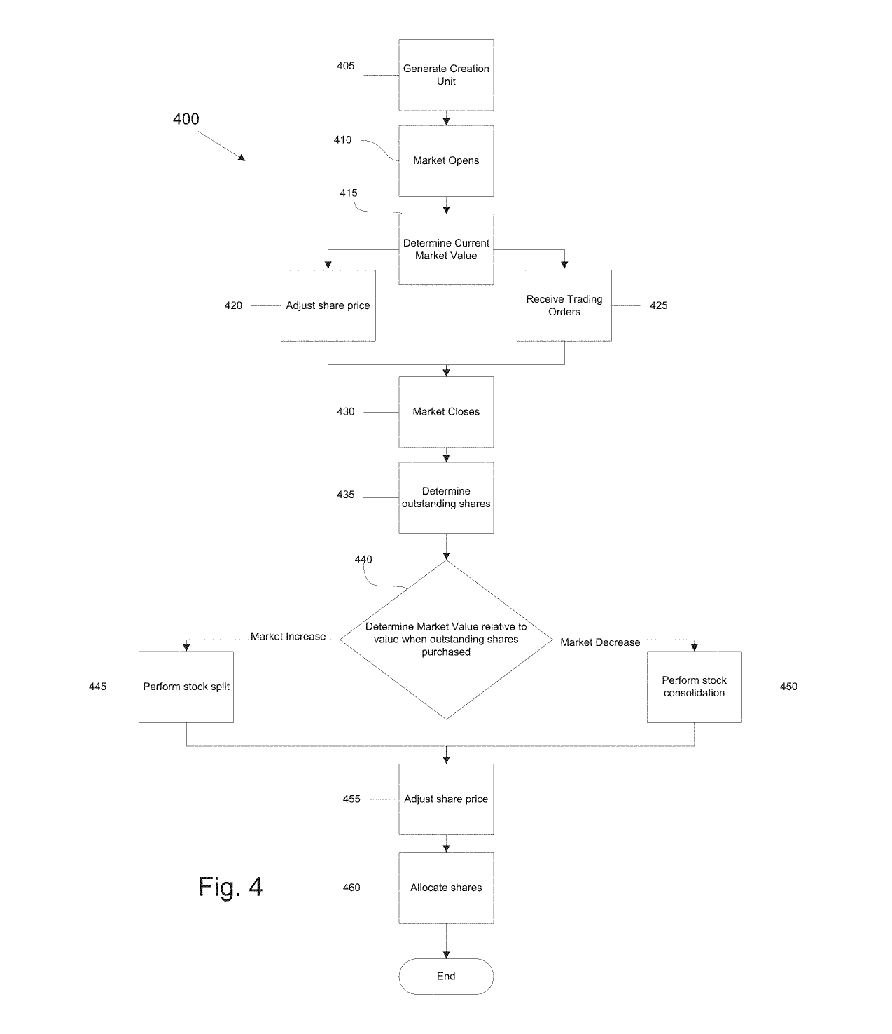

Turning now to FIG. 4, an exemplary method 400 for executing, tracking, revaluing, and allocating shares of an LETF according to one or more implementations herein is provided. The method 400 begins by generating a creation unit, step 405. In one or more implementations, the market creation module 205 implements program code to configure a processor to generate a creation unit. The value of the shares in the creation unit is tied to a multiple (e.g., 2:1, 3:1) of the value of a reference asset on the creation date, such an index, and includes one or more shares available for investors to purchase. In one or more implementations, the creation unit is generated prior to market open. Next, the method 400 continues in which a financial exchange or other trading market opens that offers shares of the creation unit for sale, step 410. For example, the market can open at 8 am. A fund (e.g., Powershares) can offer the generated creation unit for sale on a financial exchange, with the creation unit being tied to a value of the reference asset. Thereafter, the method 400 determines the value of the reference asset, step 415. This determination is made as the trading market is open, and the value of the reference asset is continuously tracked throughout the trading day.

During the trading day, the method 400 performs multiple duties simultaneously in addition to tracking the value of the reference asset. As the value of the reference asset fluctuates, the method 400 adjusts the price of the shares of the creation unit available for purchase, step 420. For example, if the initial pre-market open share price was $1, and the method 400 determines at a particular time that the reference asset has increased by 3% in value for a creation unit having a 2:1 stated multiple, then the method adjusts the available share price by 6%, to have a buy price of $1.065 and sell price of $1.055 (for an average of $1.06). During the trading day, the method 400 also receives trading orders from investors, step 425. Trading orders can be purchase or “buy” orders, or can be redemption or “sell” orders. The method executes intra-day trading via one or more modules, such as, for example, broker module 215 and execution module 225. Steps 415, 420, and 425 are repeated throughout the trading day.

At step 430, the market offering the shares of the creation unit for trading closes at a set time. For example, this can be at 4 pm. The method 400 then determines how many shares of the creation unit are outstanding, as indicated at step 435. An outstanding share is one that was purchased, but not redeemed, by an investor during the trading day, or any earlier trading day. As disclosed elsewhere herein, conventional LETF methods are unsuitable for tracking, revaluing, and allocating outstanding shares over a multiple day timeframe. The method 400 advantageously provides a way for investors to hold outstanding shares over multiple trading days by reducing the number of trades a LETF has to execute on a daily basis (i.e., by removing rebalancing), which was heretofore not possible with conventional LETF methods and systems. By not needing to implement rebalancing, the computer resources, network bandwidth, and number of executed trades necessary to manage the LETF may be reduced. Additionally, by removing the need for rebalancing, the method 400 significantly reduces financial transaction costs as well. Instead of relying on a purchase price point to rebalance the LETF portfolio after market close, the method 400 determines the value of the reference asset relative to a previous set time, step 440. For example, the value can be determined relative to creation unit date and market level when the outstanding shares were purchased or the value at last market day's reset. If the method determines that the value of the reference asset has increased since the previous set time, indicating a market increase, the method 400 performs a split, step 445. A split takes the number of shares purchased, and splits the shares to generate additional shares tied to the creation unit. For example, if the investor had purchased 50 shares of a 2× multiple creation unit at $1 when the reference asset was at 2000, and at market close, the value of the reference asset has risen to 2100 (a 5% increase), the method splits the 50 shares into 55 shares (a 10% increase). Similarly, if the method determines that the value of the reference asset has decreased from the previous set time, indicating a market decrease, the method 400 performs a consolidation, step 450. Using the same example, if the investor had purchased 50 shares of a 2× multiple creation unit at $1 when the reference asset was at 2000, and at market close, the value of the reference asset has decreased to 1900 (a 5% decrease), the method consolidates the 50 shares into 45 shares (a 10% decrease). In one or more implementations, whether the value of the reference asset has increased or decreased, the method 400 adjusts the price of the outstanding shares to a set price at step 455. For example, if the creation unit was created with a set price of $1 per share, the method 400 adjusts the outstanding share price back to $1, regardless of what price the shares were when purchased by an investor during the intra-day trading period. Thereafter, the method 400 allocates the adjusted amount of shares at the set price to the investors owning the outstanding shares, step 460.

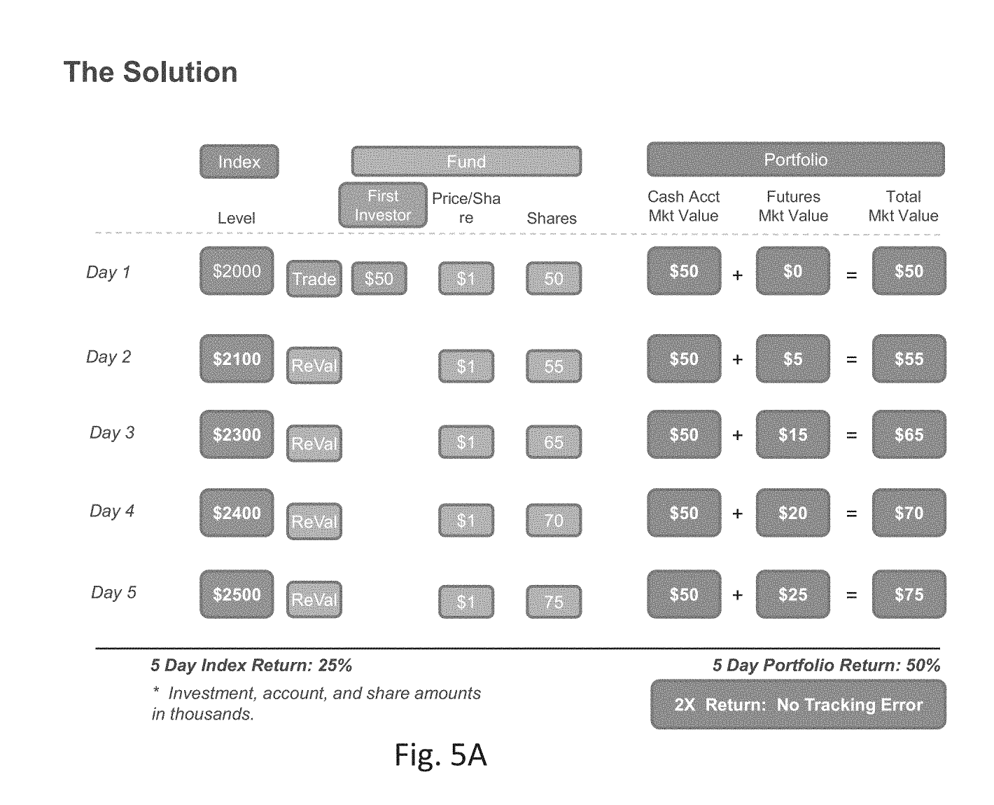

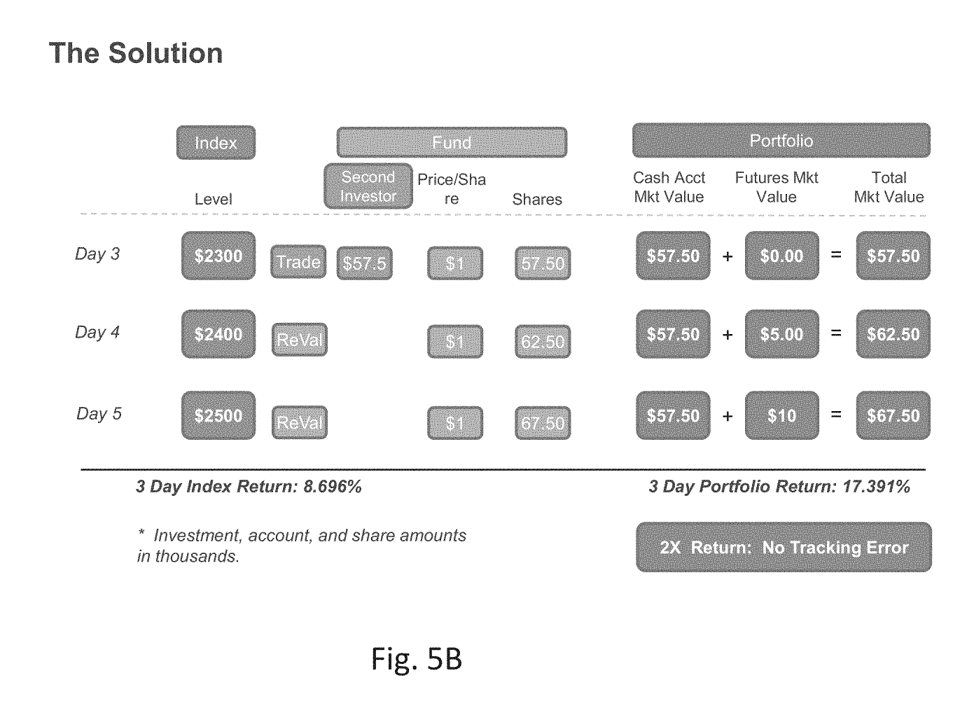

With reference now to FIGS. 5A-5B, an example of one implementation of a present system for execution, tracking, revaluing, and share allocation of a LETF implementing one or more of software modules 200 is provided. In this example, the reference asset tracked is an index with an initial value on Day 1 of $2000, and is leveraged to provide a 2:1 multiple by purchasing futures contracts that track the reference index. A first creation unit is generated representing $50 worth of shares pegged to a creation unit having a fixed price of $1/share. The system then allocates 50 shares of the fund to the creation unit, which is thereafter purchased by a first investor. As no adjustments have been made, these shares have a cash account market value of $50, and the futures value is $0, since the value of the reference index has yet to change. On Day 2, the reference index rises 5% to a value of $2100. The system then generates a share split to increase the creation unit's number of shares to 55, but does not change the fixed price per share of $1. However, the fund has not executed any rebalancing of the underlying futures position as the creation unit has not been redeemed. In this way, this method and system, configured to operate as described, reduces the number of trades a LETF has to execute on a daily basis by eliminating the need for rebalancing. This removal of rebalancing also significantly reduces financial transaction costs. The increased value in the reference index is reflected by an increase of the market value of the futures contracts (that track the reference market) from $0 to $5. This, in addition to the fixed cash account market value of $50, thereby generates a total value to the creation unit of $55 (55 shares at $1/share). On Days 3-5, the value of the reference index increases and the system generates a corresponding increase in the number of shares for the creation unit and the first investor's shares, based on increases in the futures market value of the fund's portfolio. By Day 5, the index has increased to $2500 from its initial $2000 value, corresponding to a 25% return. The first investor now has 75 shares, which correspond to a cash market value of $50 and a futures market value of $25, for a total market value of $75. This provides the first investor with a 50% return, which accurately reflects the stated 2:1 multiple of the fund.

By generating a new creation unit daily, the allocation system according to one or more implementations of the present invention is capable of accurately delivering a stated multiple regardless of which day a particular investor purchases his shares (e.g., via one or more software modules 200). In other words, if a system according to one or more implementations of the present invention generates a creation unit (sold to one or more investors) on Day X which is adjusted one or more times beyond its creation date during tracking of the reference asset and subsequent creation units (sold to multiple investors) are generated on subsequent days, then the LETF vehicle is still able to deliver the stated multiple to both the initial and subsequent creation units as well. For example, in FIG. 5B, a second creation unit represents $57.50 worth of shares purchased by a second investor on Day 3 of the example investment scenario in FIG. 5A, in which the reference index has a value of $2300. Since the price per share is fixed at $1/share, the second investor receives 57.50 shares. On Day 4, the index rises to $2400 and the system adjusts the second creation unit's shares to a total of 62.50 shares comprising the $57.50 of initial cash value and $5.00 of futures value, and allocates the additional shares to the second investor. On Day 5, the index rises to $2500, and the system generates a corresponding 67.50 shares ($57.50 in cash value, $10 in futures market value) for the second creation unit, which is again allocated to the second investor. The index has returned 8.696% in this timespan and the second creation unit's corresponding siloed portfolio has returned 17.391%, which maintains the 2:1 stated multiple return.

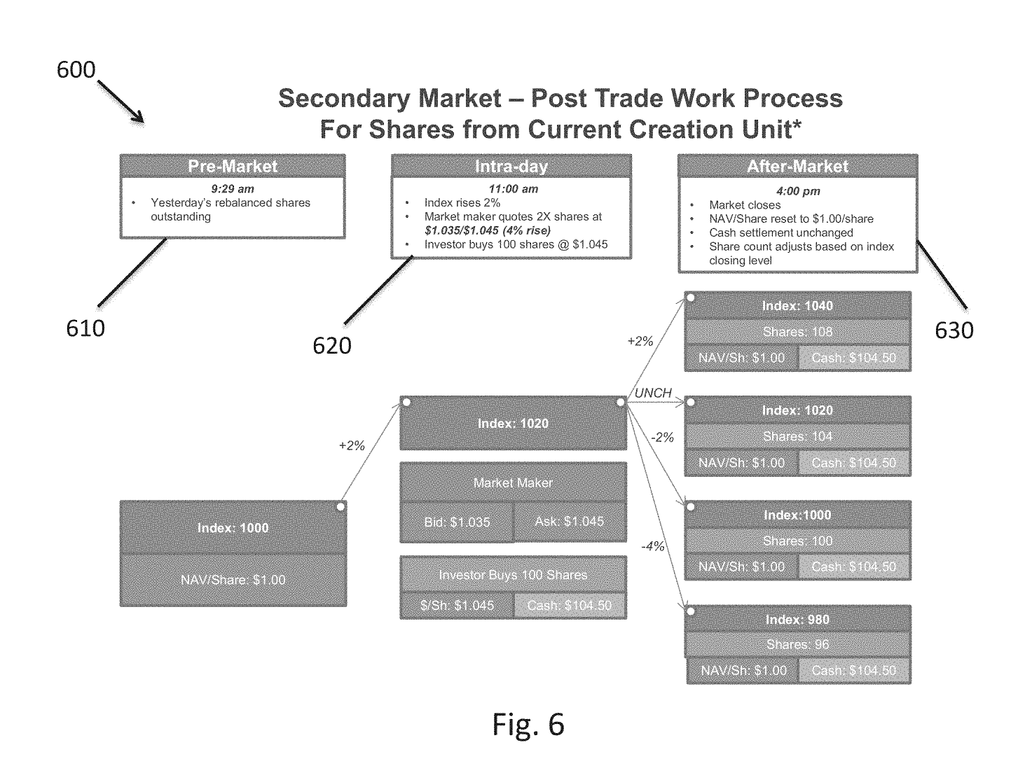

FIG. 6 illustrates an exemplary method 600 of processing intra-day purchases of shares in regard to the current day's creation unit according to one or more implementations of the present invention. For intra-day trading as in the method 600, the method can be broken into three main phases, depending on the time of day. At phase 610, the method 600 accounts for pre-market activity. At phase 620, the method 600 processes intra-day purchase and redemption (buy/sell) of LETF shares. At phase 630, the method 600 processes after-market close activity.

In the pre-market phase 610, the method 600 begins in which a LETF vehicle having a set multiple (e.g., 2:1, 3:1, −2:1, −3:1, etc.) and a generated creation unit set with a share price of $1, that tracks one or more reference asset(s). This creation unit can be generated by, for example, market creation module 205. In this example, the underlying reference asset is an index having a value of 1000 prior to market open. Then, in phase 620 for intra-day trading, this example demonstrates that two hours after market open, the reference index has risen to 1020. A Market Maker quotes a bid (sell) price of $1.035 and an ask (buy) price of $1.045, which corresponds to a 4% rise plus the Market Maker's commission fee (as the index has increased by 2%). In one or more implementations, the Market Maker implements various software modules disclosed herein to facilitate trading of LETF shares, such as market maker module 210. Next, an investor places a buy order for 100 shares of the LETF. For example, the buy order can be placed at a user computing device 130 by implementing one or more of the software modules 200 (such as market maker module 210 and/or broker module 215). At the quoted $1.045 ask price, the investor purchases the 100 shares with $104.50 in cash. In one or more implementations, purchase or redemption is performed by execution module 225. This process is repeated for each investor that desires to make a trade, with the bid/ask prices being varied by a Market Maker depending on the underlying reference index value. In this way, the intra-day share price does change and the number of shares bought or sold is paid for based on the adjusted shares as of the previous day's reset time. The transaction for the total price paid settles into the new adjusted number of shares as of the next set time. At a set time thereafter, the market closes. At that time, or another specified time between then and the next market open, the exemplary method 600 moves into phase 630 and executes broker module 215 to adjust the investor's number of shares (based on the initial creation unit price of $1.00 per share). Depending on the performance of the reference index after the investor's purchase and before the market closes, the broker module 215 adjusts the investor's number of shares to reflect the market value at the daily share adjustment time relative to purchase price or another fixed price (e.g., $1). This can be done through splits or consolidations. For example, if index closed unchanged from the investor purchase at a NAV of 1020, then the investor's share amount would increase to 104 shares to reflect the share reset. If the index increased, such as by 2% to 1040, the number of shares would adjust to 108. However, if the index value decreased, such as back to the opening value of 1000 (−2% from purchase) or to 980 (−4% from purchase), then the number of shares would be adjusted to 100 or 96 respectively. In all cases, the cash settlement of $104.50 for the initial number of shares remains unchanged, and only the number of adjusted shares varies. This example method 600 assumes that the pricing of intra-day trading of shares is linked to the current day's creation unit of a 2× LETF. If the trades made are linked to creation units other than the current day, then the market maker module 210 will adjust pricing correspondingly.

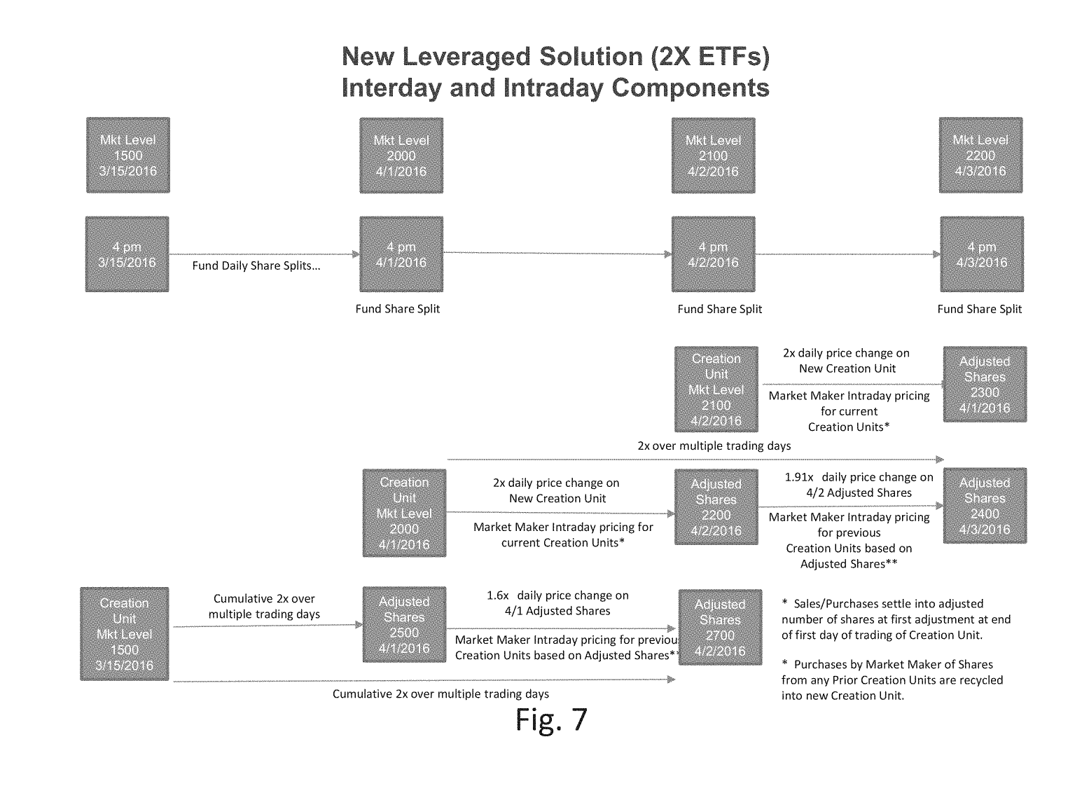

FIG. 7 illustrates the inter-day and intra-day components of the methods and systems according to one or more implementations of the present invention. In one or more implementations, the systems and methods herein create a creation unit for each trading day, and adjust shares relative to the creation unit created on a particular date after each market close to maintain the stated multiple. In this way, the investor's shares are tied to the day that the investor made the purchase, rather than the price at which the investor made the purchase. This is achieved by implementing a daily multiple that changes depending on the change in value of the underlying reference asset, though over the cumulative period the return is the stated multiple of the LETF (e.g., 2×).

The example illustrates a reference index having a value of 1500 on a first day and a first creation unit created on that day, in which each of the shares in the creation unit has a fixed price of $1 per share. Intra-day trading then occurs until market close, as disclosed herein (e.g., method 600). At the close on Day 2 (representing cumulative days for illustration), the value of the reference asset rises to 2000, for a rise of 33%, and a second creation unit is created for new investors who purchase shares on Day 2. Investors who purchased shares of the first creation unit but have yet to redeem their shares have their shares adjusted at the end of each day including at the close of Day 2. FIG. 7 shows that such investors that purchased on Day 1 would have their shares adjusted cumulatively from 1500 to 2500 (a change of 66%, in keeping with the 2× multiple).

At the close on Day 3, the value of the reference asset rises from 2000 to 2100, and a third creation unit is created. For the investors who purchased on Day 1, their shares are adjusted to 2700 because the reference asset returned a day-to-day multiple of 1.6× relative to Day 2. This 1.6× daily multiple is based on the creation date and market level of the first creation unit in order to assure a 2× cumulative return over the lifetime of that creation unit, and is calculated as a day-over-day value. Over the cumulative time period, the present systems and method still return the stated multiple (2× in this example). For investors who purchased on day 2, as the value of the reference asset for the second creation unit has gone from 2000 to 2100 (a 5% increase), the shares for the second creation unit are adjusted 10% from 2000 to 2200. It should be noted that the first reset of a creation unit always equals the stated multiple of the LETF.

Continuing with this example, at the close on Day 4, the value of the reference asset rises to 2200 and a fourth creation unit is created as there is an inflow of investments and the assets under management (AUM) of the LETF increases. For investors who purchased from the second creation unit, those shares are adjusted by a 1.91× daily multiple relative to the Day 3 reference asset price. For investors who purchased on day 3, their shares are adjusted from 2200 to 2400 to maintain the 2× multiple.

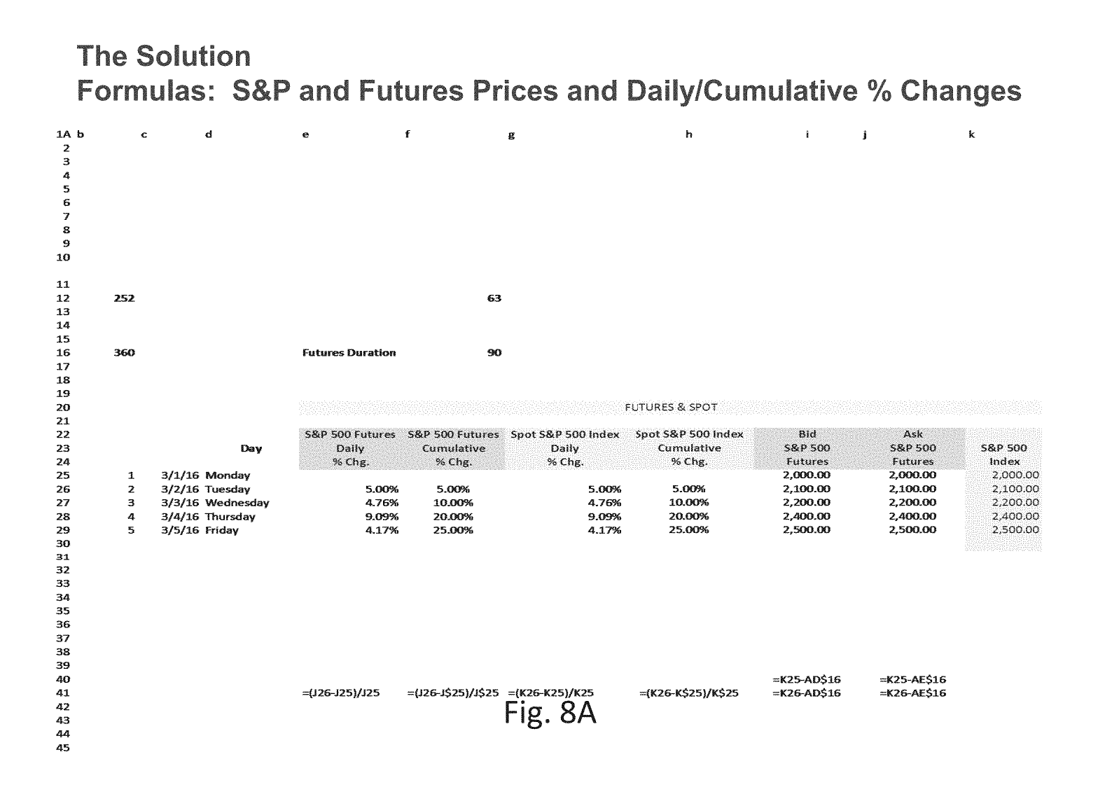

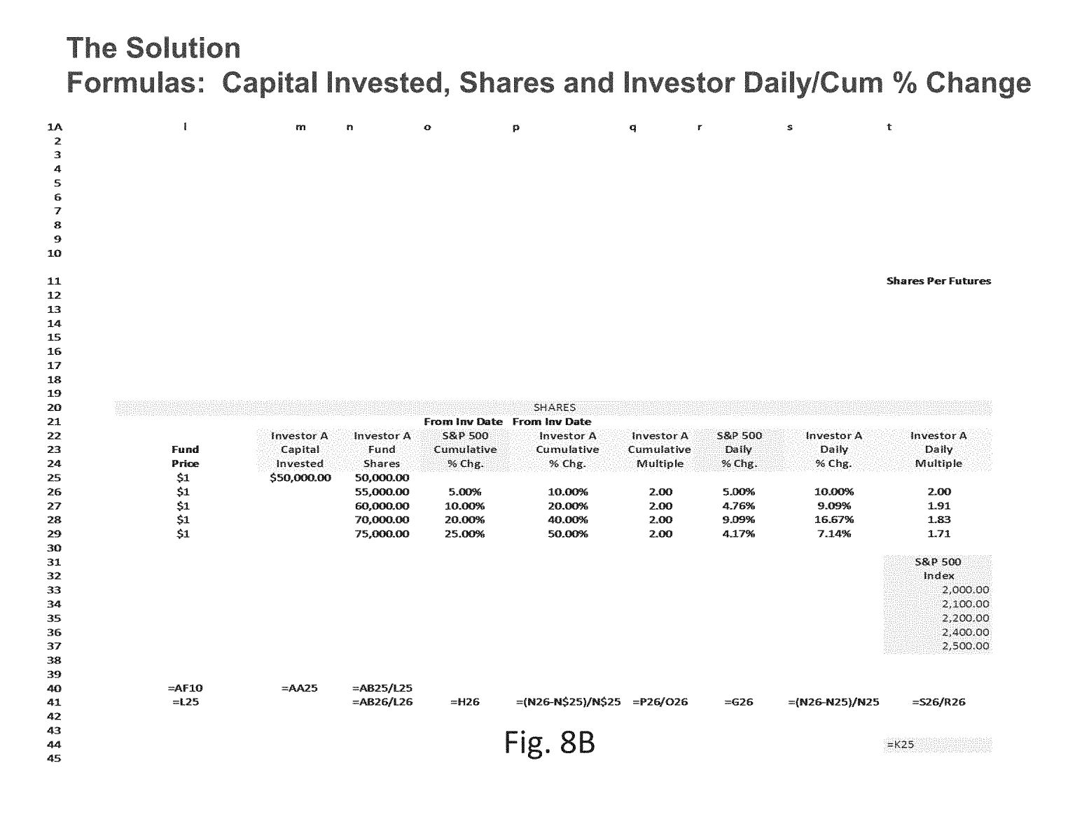

With reference now to FIGS. 8A-8B, another example of the systems and methods disclosed herein is illustrated. FIGS. 8A-8B depict a week of trading of a LETF vehicle that is tied to the S&P 500 to provide a 2:1 multiple return by generating exposure by purchasing S&P 500 futures.

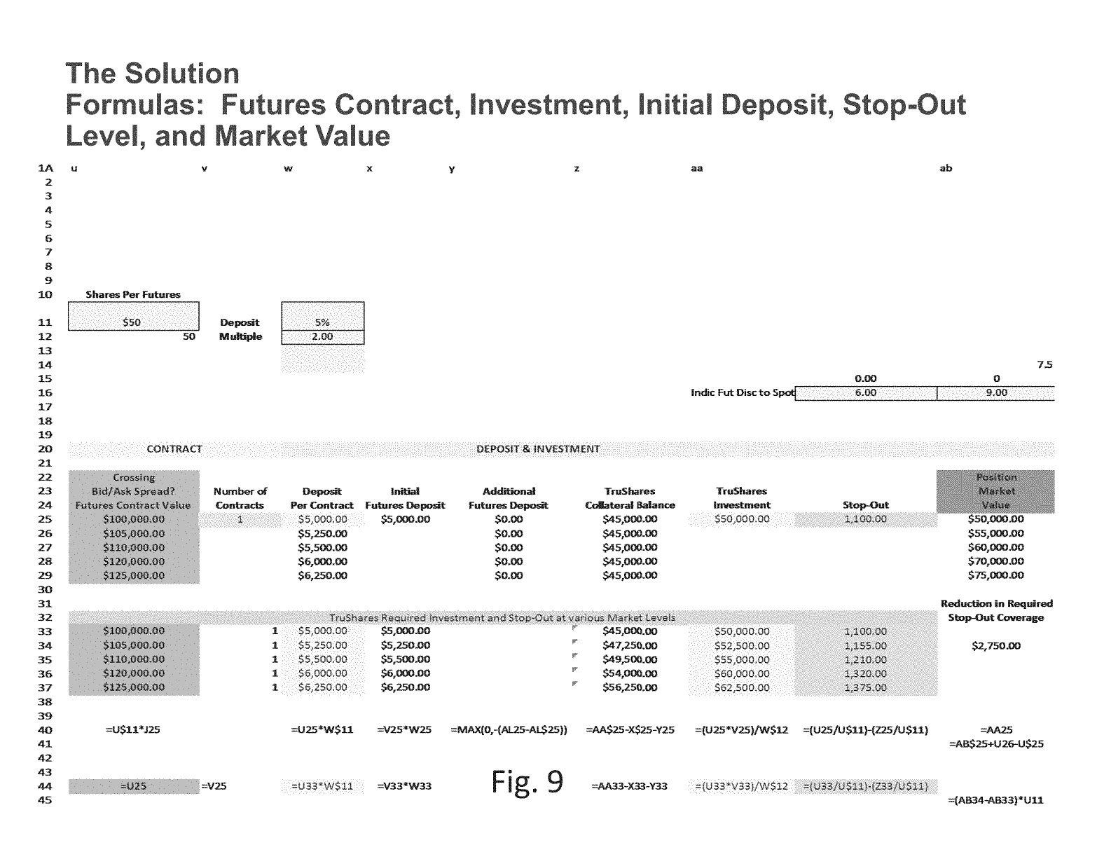

With reference now to FIG. 9, an exemplary implementation of how the methods and systems herein generate market exposure is provided. While market exposure can be generated in various ways, such as by using swaps, FIG. 9 generates market exposure by investing in futures contracts. For example, the initial creation unit value here is $50,000. To generate a 2:1 multiple, $100,000 in futures contracts must be purchased. Futures contracts require an initial deposit, which in this case is 5% of the contract value, or $5000 for a $50,000 market value, leaving a collateral balance of $45,000. LETFs also require a stop-out clause so that the position of the LETF will be liquidated by the LETF once there is no cash balance to support the LETF's futures position. For example, for a $100,000 contract, the stop-out value is $1,100, meaning if the value of the shares drops to this level, trading of the shares is suspended and they are redeemed with any cash balance remaining returned to the investor. As the reference asset increases in value, additional future contracts are purchased as shown. If the reference asset decreases in value, future contracts are redeemed.

The LETFs of the present disclosure use technological tools in an unconventional way to manage shares in accordance with a new paradigm which is not known in the field of LETFs. In contrast to conventional LETFs, the present invention eliminates the need to rebalance the LETF daily. Inter-day reference asset changes are reflected through end of trading day share splits or consolidations. Each day Market Makers create creation units from the LETF and then sell shares to investors, and make a market, through a Broker Dealer network, for example. Each day's creation unit, and the individual shares issued therefrom, is tracked in a separate silo for that day. Subsequently, all outstanding creation units and shares issued therefrom are revalued once a day at close of trading via a share split/consolidation of the number of shares owned by the investors each day. Such revaluing does not require conventional LETF rebalancing of the underlying fund's portfolio. Investors who purchase LETF shares on a different trading day have their purchases tied to that day's creation unit. When an investor sells its shares, those shares are sold relative to that creation unit's basis. To account for intra-day price moves since the last share adjustment, Market Makers quote a price based on the reference asset's move relative to the previous end of day adjustment and also adjust shares relative to the initial market level from the shares purchase date. Separately, if the investor buys shares intra-day from the current day's creation unit at a market level different from the level when the current day's creation unit was issued, the investor's intra-day daily multiple may differ from the multiple stated. In cases where creation units from earlier trading days are redeemed, the present system implements one or more software modules to recycle the LETF's position in futures, derivatives, and underlying assets from the prior creation unit into the next day's creation unit where applicable and feasible. In one or more implementations, this is accomplished via cash or other funds from a collateral account. In any case, the present systems and methods do not require selling of underlying futures, derivatives, or assets unless creation units are redeemed which is generally driven by a minimum net sale of shares during the trading day.

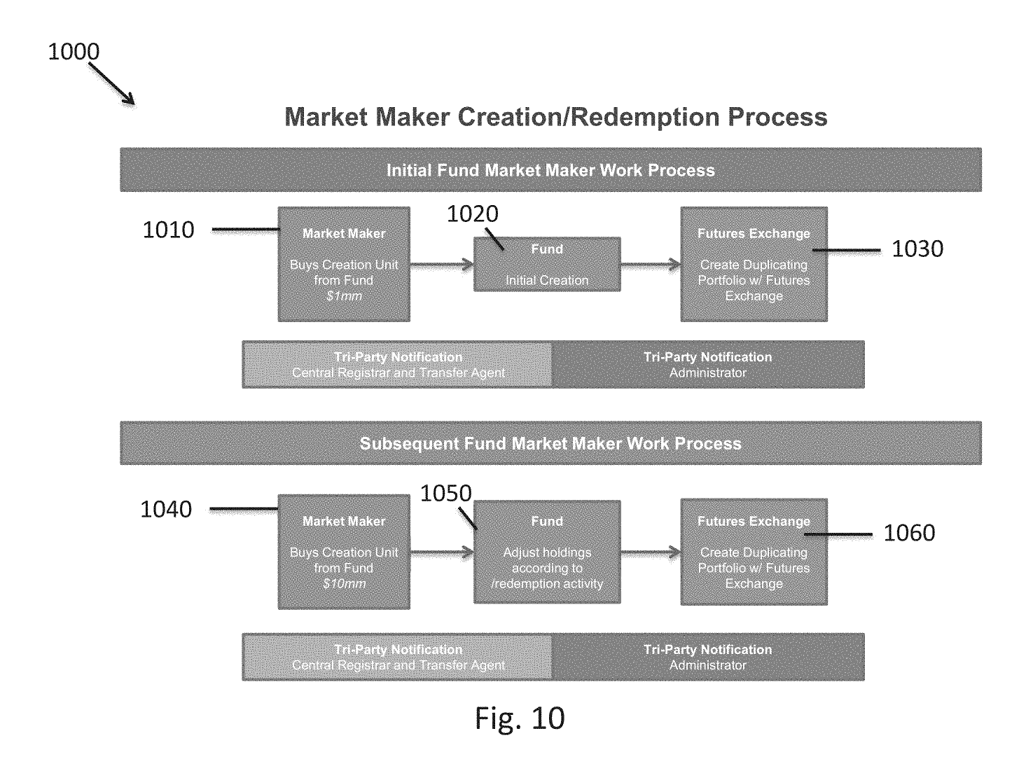

FIG. 10 presents flow diagrams illustrating a creation unit creation and redemption method 1000 according to one or more implementations herein. The Market Maker creation and redemption method 1000 begins at step 1010 when a Market Maker places an order to generate an initial creation unit to track a reference asset according to a stated multiple from a fund, such as Powershares. For example, the initial creation unit has a size of $1 million. This includes Tri-Party Notification between the Market Marker, a Central Registrar, and a Transfer Agent to coordinate generation of a creation unit. At step 1020, the creation unit is created as described elsewhere herein. The method 1000 includes creating a portfolio that duplicates the performance of the reference asset except at the stated multiple, step 1030. For example, the method 1000 purchases $2 million in portfolio exposure to provide a 2:1 multiple return on a $1 million creation unit. In one or more implementations, the created duplicate portfolio comprises futures contracts. In one or more implementations, the created duplicate portfolio comprises swaps.

FIG. 10 additionally illustrates the subsequent fund Market Maker work process after an initial creation unit has been generated for investors who decide to make additional purchases or redemptions at a later date. At step 1040, a Market Marker requests creation of one or more additional creation units, as in one or more implementations disclosed herein. For example, the Market Maker may request an additional $10 million in creation unit shares. As at least one creation unit has previously been created (i.e., at step 1020), the method 1000 then adjusts the outstanding shares in the initial creation unit according to purchase and redemption activity. The difference between the initial creation unit size and the second creation unit is settled by transferring the additional money invested into the fund and that capital is applied for the new day's creation unit. For example, since $1 million in shares had already been generated by steps 1010 and 1020, and the Market Maker desires a second creation unit having a net value of $10 million in total after the days trading activity, $10 million in market position is required to be added. Additional market position is created by creating a portfolio that duplicates the performance of the reference asset at the stated multiple as in the initial process, step 1060. For example, an additional $20 million in exposure is necessary to create the $10 million creation unit, as $2 million in exposure is already generated at step 1030. In the event that a Market Maker desires reduction of the size of the creation unit position, such as in the event redemption of part or all of an old position is desired, the process 1000 adjusts the holdings at step 1050 and 1060 by selling the portfolio exposure (e.g., to reduce a $10 million creation unit to $1 million, $18 million in portfolio exposure is sold).

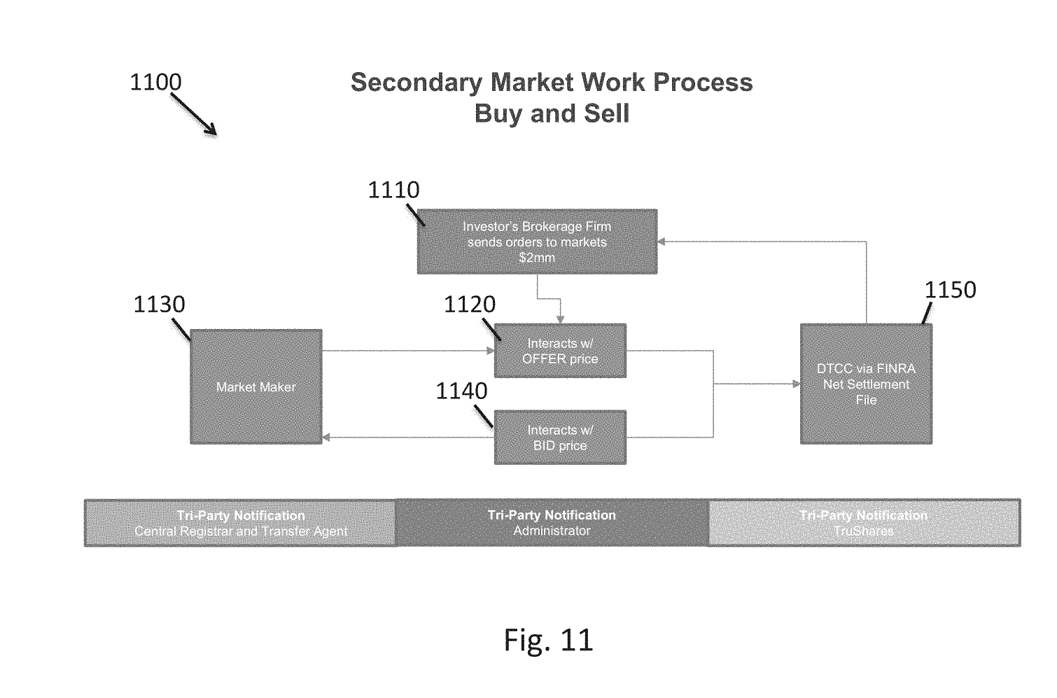

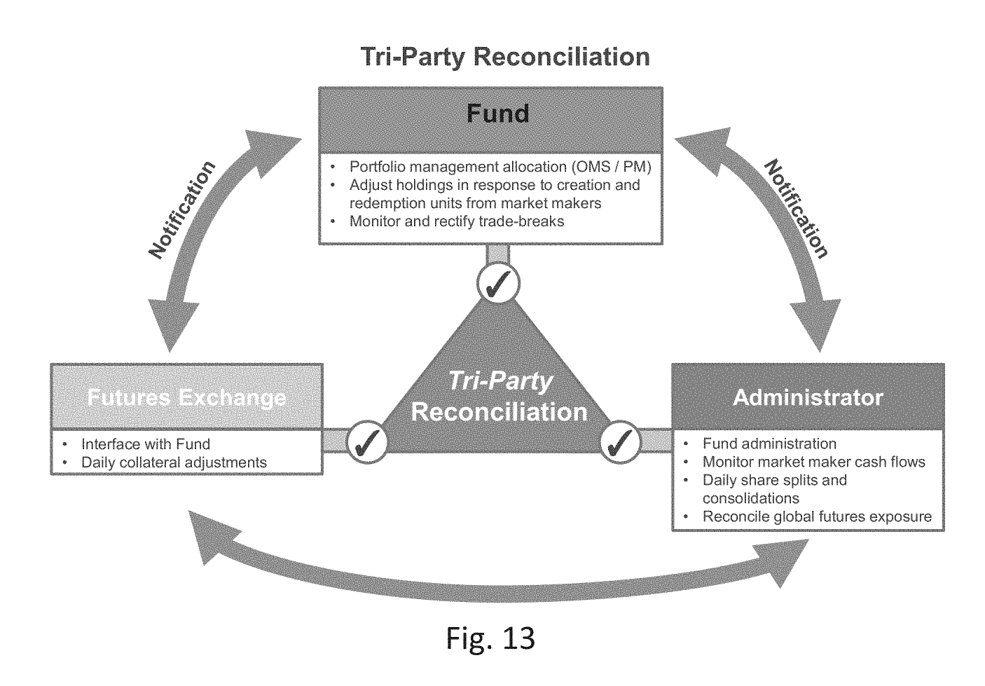

FIG. 11 presents a flow diagram illustrating the secondary market work process 1100 according to one or more implementations. The secondary market work process is the purchase and redemption of shares of a creation unit by investors with a Market Maker. Process 1100 begins with an order sent by an investor to the Market Maker, step 1110. For example, a brokerage firm may wish to make a $2 million purchase order of LETF shares. A Market Maker 1130 facilitates such trades by providing an ask or buy price in the event of a purchase order, step 1120. In the event of a sales order, a bid or sell price is offered by the Market Maker, step 1140. If the ask or bid price is acceptable to the investor, the trade is executed and Tri-Party notification is made as in FIG. 13. Thereafter the Depository Trust and Clearing Corporation (DTCC) receives the net settlement of the trade via the Financial Industry Regulatory Authority (FINRA), as is known in the art.

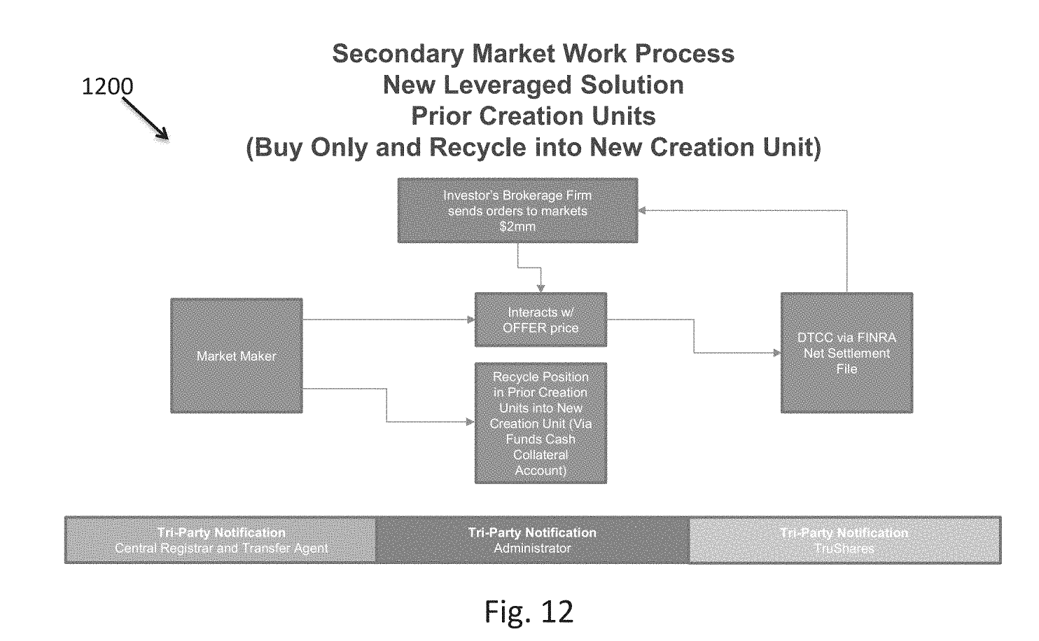

FIG. 12 presents a flow diagram illustrating the process 1200 of recycling of shares into new creation units according to one or more implementations. Process 1200 is the same as process 1100, except that shares of a previous creation unit are outstanding, and are recycled into a new creation unit as in method 1000.

FIG. 13 presents an exemplary administrative notification system implemented by the methods and systems according to one or more implementations. As shares of LETF vehicles are bought and sold as described elsewhere herein, in one or more implementations, the participating actors communicate to provide notifications of when aspects of the LETF vehicle need to be rebalanced, such as in share adjustment due to changes in tracked market value. Notification may be performed by one or more modules described herein (e.g., communication module 220).

The fund that generates the creation unit (e.g., Powershares) is responsible for portfolio management allocation, adjustment of holdings in response to creation and redemption units from Market Makers, and monitoring and rectifying trade breaks. As the fund performs such duties, it must notify the fund administrator and the exchange that the portfolio is being adjusted so that corresponding changes can be made to ensure that the LETF vehicle maintains its stated multiple. For example, the exchange is notified when the fund needs to make end of day adjustments to share holdings because of market movement, as the exchange executes the purchases or sales of shares. Additionally, for example, the fund administrator is notified as to the status of the tracked reference asset at the end of a trading session in order to administer share splits or consolidations.

FIGS. 1 through 17 are conceptual illustrations allowing for an explanation of the present invention. Those of skill in the art should understand that various aspects of the implementations of the present invention could be implemented in hardware, firmware, software, or combinations thereof. In such implementations, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine-readable medium as part of a computer program product, and is loaded into a computer system or other device or machine via a removable storage drive, hard drive, or communications interface. Computer programs (also called computer control logic or computer readable program code) are stored in a main and/or secondary memory, and implemented by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single implementation, as other implementations are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific implementations will so fully reveal the general nature of the invention that others can, by applying knowledge within the skill of the relevant art(s) (including the contents of the documents cited and incorporated by reference herein), readily modify and/or adapt for various applications such specific implementations, without undue experimentation, without departing from the general concept of the present invention. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various implementations of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary implementations, but should be defined only in accordance with the recitations in any claims and their equivalents.

What is claimed is:

1. A method of managing a leverage exchange traded fund (LETF), the LETF having an exposure ratio proportional to a multiple of the change in value of a reference asset over time, the method comprising:
generating, at a first set time, a first creation unit having a first creation date, the first creation unit including one or more shares relative to the value of the reference asset at the first set time, each share having a first set price value;
receiving, one or more trading orders purchasing one or more shares by one or more purchasers;
determining, at a second set time, which of the one or more shares were purchased but not yet redeemed by the one or more purchasers since the first set time;
determining, at the second set time, the value of the reference asset and determining, as a second price, the price of the one or more purchased shares;
in the event that the value of the reference asset has increased, adjusting the number of unredeemed shares by performing a split relative to the first creation date and the value of the reference asset at the second set time;
in the event that the value of the reference asset has decreased, adjusting the number of unredeemed shares by performing a consolidation relative to the first creation date and the value of the reference asset at the second set time;
adjusting the second price of the adjusted unredeemed shares to the first set price; and
allocating the adjusted number of unredeemed shares to each of the one or more purchasers.

2. The method according to claim 1, further comprising:
determining, at a third set time, which of the one or more shares of the creation unit are available for purchase;
determining, at the third set time, the value of the reference asset;
adjusting the price of the available one or more shares to a third price,
wherein the third set time is after the first set time but before the second set time.

3. The method according to claim 1, further comprising:
generating, at the second set time, a second creation unit having a second creation date, the second creation unit including one or more shares relative to the value of the reference asset at the second set time, each share having a set price value.

4. The method according to claim 1, wherein the adjustment of the number of unredeemed shares by a split or a consolidation includes adjusting the number of unredeemed shares to maintain the exposure ratio proportional to the multiple of the change in value of an reference asset over time.

5. The method according to claim 1, further comprising, determining, prior to the first time, the value of the reference asset.

6. A system for managing a leverage exchange traded fund (LETF), the LETF having an exposure ratio proportional to a multiple of the change in value of a reference asset over time, the system comprising:
a computing device, the computing device having a processor, a memory, and a communication link to a network;
a central server configured to, across the network, interface with one or more financial exchanges and the computing device;
a market creation module implementing instructions stored in the memory by the processor to configure the processor to:
generate, at a first set time, a first creation unit having a first creation date, the first creation unit including one or more shares relative to the value of the reference asset at the first set time, each share having a set price value at the first set time; and
receive, one or more trading orders purchasing one or more shares by one or more purchasers;
a market maker module implementing instructions stored in the memory by the processor to configure the processor to:
receive, one or more trading orders purchasing the one or more shares by one or more purchasers,
an execution module implementing instructions stored in the memory by the processor to configure the processor to:
execute the one or more received purchase orders by transmitting the one or more trading orders to the central server; and
a broker module implementing instructions stored in the memory by the processor to configure the processor to:
determine, at a second set time, the value of the reference asset relative to the first set time,
adjust the one or more shares purchased but not redeemed from the creation unit,
in the event that the value of the reference asset has increased, perform a split to generate additional shares to account for the difference of the value of the reference asset at the first set time and the second set time, or
in the event that the value of the reference asset has decreased, perform a consolidation to redeem one or more shares to account for the difference of the value of the reference asset at the first set time and the second set time,
adjust the price of the adjusted unredeemed shares to the price of the one or more shares at the first set time, and
allocate the adjusted number of unredeemed shares to each of the one or more purchasers.

7. The system according to claim 6, wherein the market maker module is configured to:
determine the value of the reference asset at a third set time,
adjust the set price value of the one or more shares relative to the determined reference asset value, and
offer the one or more shares for purchase at the adjusted price value.
